(19) United States
(12) Patent Application Publication
(10) Pub. No.: US 2018/0232821 A1
(43) Pub. Date: Aug. 16, 2018

(54) RESTAURANT ORDERING SYSTEM AND METHOD

(71) Applicant: Peigen Jiang, Sammamish, WA (US)

(72) Inventor: Peigen Jiang, Sammamish, WA (US)

(21) Appl. No.: 15/431,995

(22) Filed: Feb. 14, 2017

(51) Int. Cl. G06Q 50/12; G06Q 30/06; G06Q 20/10

(52) U.S. Cl. CPC G06Q 50/12; G06F 17/30528; G06Q 20/10; G06Q 30/0635

(57) ABSTRACT

A restaurant ordering process operative in a server includes parsing a first plurality of packets received from a first computing device over the Internet, extracting a first order and a first serial code from the first plurality of packets, parsing a second plurality of packets received from a second computing device over the Internet, extracting a second order and a second serial code from the second plurality of packets, creating a third plurality of packets carrying the first order, the second order and the first serial code upon receiving an instruction from either the first or the second computing device or both to do so if the first and the second serial code are the same, and transmitting the third plurality of packets to a third computing device placed in a restaurant.

### BACKGROUND

The present invention relates generally to a system and method for placing orders in a restaurant, and, more particularly, to a system and method for allowing customers to place order themselves.

Traditional sit-down restaurants employ wait persons to take orders from customers and then deliver their ordered food to the table. Often time a wait person takes care several tables and may not be able to attend a newly arrived customer right away. Sometime a wait person may make mistakes. When served by a wait person, customers are obliged to pay gratuity which will increase meal cost for the customers. As such, it is desirable for restaurant owners to simplify the order taking process and to reduce labor cost.

### BRIEF DESCRIPTION OF THE DRAWING

FIG. 1 illustrates a restaurant ordering system in accordance with an embodiment of the present invention.

FIG. 2 is a flow-chart illustrating an ordering operation of the restaurant ordering system shown in FIG. 1.

FIG. 3 is another flow-chart illustrating an alternative ordering operation of the restaurant ordering system shown in FIG. 1.

FIG. 4 illustrates a webpage in accordance with an embodiment of the present invention.

FIG. 5 illustrates flow of packets in the restaurant ordering system in accordance with embodiment of the present invention.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The present invention relates to a restaurant ordering system and method that enables customers to place order on their personal smartphones. A preferred embodiment of the present invention will be described hereinafter with reference to the attached drawings.

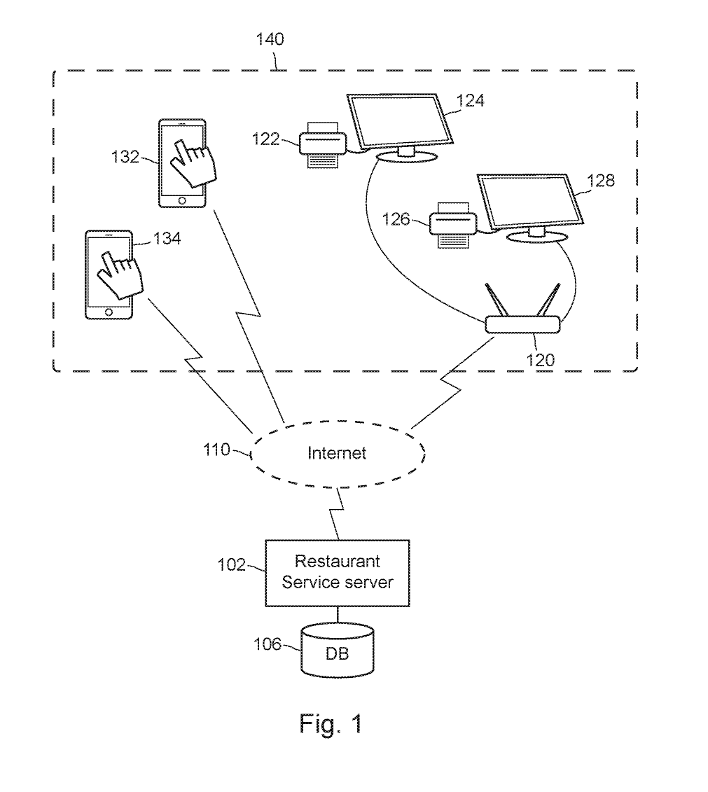

FIG. 1 illustrates a restaurant ordering system in accordance with an embodiment of the present invention. The restaurant ordering system utilizes a restaurant service server 102 and a database 106 to supply restaurant menu information to and receive order information from exemplary smartphones 132 and 134 through the Internet 110. The restaurant service server 102 may be placed in an internet service provider (ISP) and run various restaurant service applications including managing the database 106, processing order information and issuing orders to exemplary computer terminals 124 and 128 through an exemplary router 120. The router 120 may provide a Wi-Fi network coverage throughout the restaurant premises, so that the computer terminals 124 and 128, as well as the smartphones 132 and 134 can be connected to the Internet through the Wi-Fi network. Printers 122 and 126 are attached to the computer terminals 124 and 128, respectively, for printing out instructions such as which menu items have been ordered by the customers.

In another embodiment, the restaurant service server 102 may be placed in the restaurant and provide a private Wi-Fi network cover to the restaurant premises, so that orders from customers located within the restaurant can be processed locally without going through the Internet. However, the restaurant service server 102 is still connected to the Internet communicating with proxy servers and the database 106 located in an ISP.

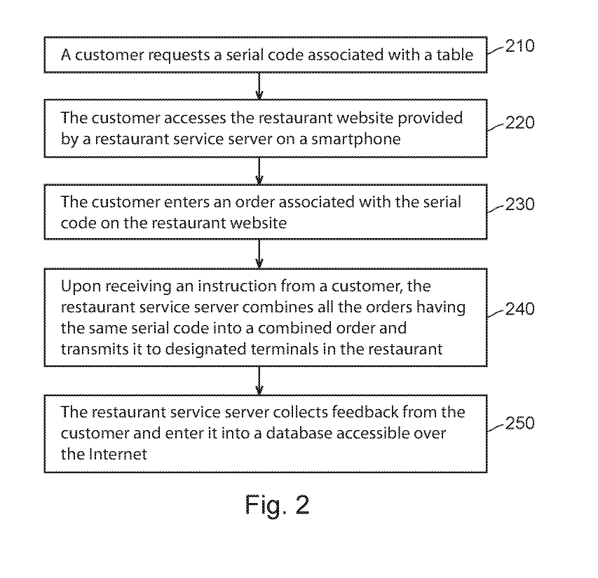

FIG. 2 is a flow-chart illustrating an operation of the restaurant ordering system shown in FIG. 1. When one or more customers enter a restaurant, they are normally greeted by a hostess and ushered to a table if one is available. The ordering operation starts in step 210 with the customer requests a serial code associated with the table. At the same time the hostess may remind the customers the restaurant's website address, such as www.worldfood.com/123.htm, wherein the “worldfood.com” is a uniform resource locator (URL) of a restaurant service website, and “123.htm” is a webpage therein dedicated to the restaurant where the customer is currently served.

In step 220, the customer accesses the restaurant's webpage provided by the restaurant service server 102 of FIG. 1 on a smartphone. The restaurant's webpage provides a menu and allows customers to place order for items on the menu as well as entering special requests or instructions. In embodiments, the restaurant's webpage contains clickable buttons for customers to enter orders, and text boxes for customers to enter requests or instructions such as asking for extra utensils or more water.

In step 230, the customer enters an order and associates the order with the serial code which is entered onto the restaurant's webpage on the customer's smartphone at any time before entering the order. In embodiments, the restaurant′ webpage may prompt the customer to enter the serial code as soon as the webpage is accessed or when an order is attempted. At the same time, other customers at the same table may browse and order items on the restaurant's webpage on his or her own smartphone, and such orders are associated with the same serial code.

In step 240, upon receiving an instruction from the customer, the restaurant service server combines all the orders having the same serial code into a combined order and transmits it to designated terminals in the restaurant. In embodiments, a group of two or more customers may sit at the same table and receive the same serial code. Each customer may place his or her own order on his or her own smartphone using the same serial code. Once at least one customer in the group enter an instruction to close the order, the restaurant service server starts to perform step 240. Alternatively, the restaurant service server may not perform step 240 until every received order is closed. After receiving the combined order, the restaurant can proceed to fulfil the order like a conventional restaurant does. In case a request is received by the restaurant webpage, the restaurant service server forwards the request immediately to a designated terminal such as a bus station, at the restaurant. In embodiments, the combined order, request or instruction is in a natural language format and can be transmitted to a simple display terminal or a printer in the restaurant.

In embodiments, each customer can pay for his or her own order on the restaurant's webpage with a credit card on his or her own smartphone. Alternatively, the restaurant's webpage may allow a customer to pay for a part or a whole of the combined order. In other embodiments, if the combined order is not paid before the food is served and finished, the hostess may produce a check for the combined order through the restaurant service server and present it to the customers in a conventional way. In embodiments, the hostess is given a password for accessing the restaurant service server to view orders, requests and instructions placed on the restaurant webpage at any time. The restaurant service server stores every order in the database and each stored order is tracked by its serial code.

In step 250, the restaurant service server collects feedback from the customer and enter it into a database accessible over the Internet. In embodiments, the restaurant service server may request email address of the customer for later sending a reminder for such feedback. The customer may be required to enter the serial code for verifying that he or she is indeed the customer. The restaurant service server may prompt the customer to associate his or her feedback to a certain food item, and such information will all be saved in the database.

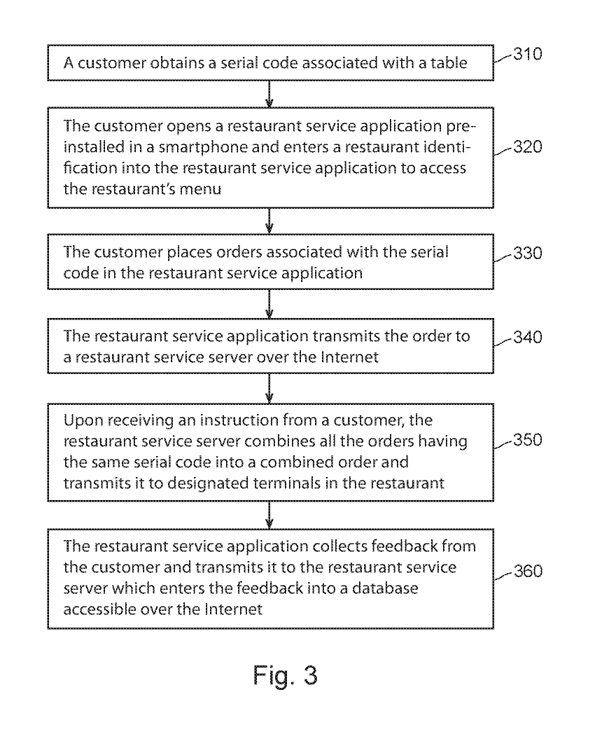

FIG. 3 is another flow-chart illustrating an alternative ordering operation of the restaurant ordering system shown in FIG. 1. In step 310, a customer upon entering a restaurant and being assigned a table obtains a serial code associated with the table. In step 320, The customer opens a restaurant service application preinstalled in a smartphone and enters a restaurant identification into the restaurant service application to access the restaurant's menu. In step 330, the customer places orders associated with the serial code in the restaurant service application. In step 340, the restaurant service application transmits the order to a restaurant service server over the Internet. In step 350, upon receiving an instruction from a customer, the restaurant service server combines all the orders having the same serial code into a combined order and transmits it to designated terminals in the restaurant. In step 360, the restaurant service application collects feedback associated with the order items from the customer and transmits it to the restaurant service server which enters the feedback into a database accessible over the Internet.

Although a smartphone is used to place order in a restaurant's premises as described above, in another embodiment, a computer (such as a tablet) coupled to the Internet supplied by the restaurant can also be used to perform the ordering process illustrated in FIG. 2 or FIG. 3. In other embodiments, customers can be away from the restaurant's premises and place delivery order or even in the restaurant place a to-go order. In such cases, the customers obtain serial codes from the restaurant's webpage, and associate the serial codes with people's names. The serial codes are generated by the restaurant service server based on a predetermined algorithm with a goal to distinguish each order. When two or more customers are within a group, they may be advised to acquire only one serial code and share it among all the customers within the group, so that their order can be combined. If they choose not to share their orders, they can certainly request serial codes individually.

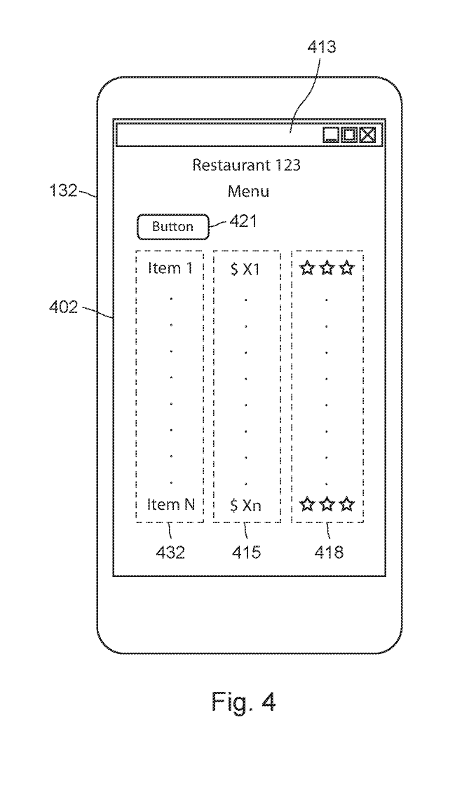

FIG. 4 illustrates a webpage in accordance with an embodiment of the present invention. The webpage is supplied by the restaurant service server 102 shown in FIG. 1 when a restaurant's URL is entered, and exemplarily displayed on the smartphone 132 that has a screen 402. There is a menu bar on top of the webpage. Below the menu bar 413, the restaurant's name, “Restaurant 123” is displayed. A button 421 is for users to enter or request a serial code. Menu items 432 are displayed along with their prices 415 and review ratings 418 if there is any. The review ratings 148 are collected from previous customers as feedbacks and stored in the database 106 which is maintain by the restaurant service server 102 shown in FIG. 1. When one of the menu items 432 is tapped, a new webpage (not shown) detailing the tapped menu item will be loaded on the smartphone screen 402, and an order can be placed and closed on the new webpage.

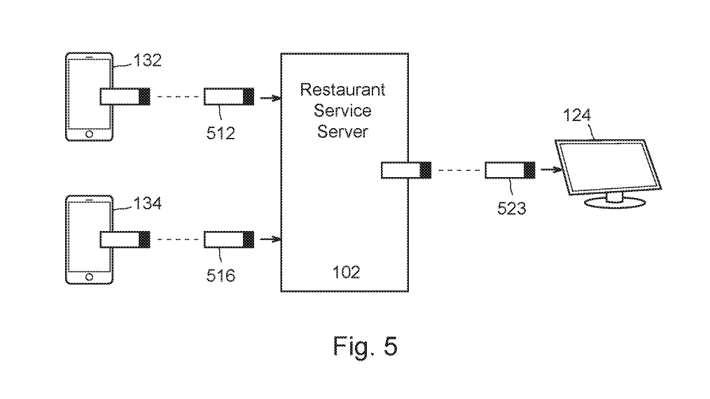

FIG. 5 illustrates packet flows in the restaurant ordering system in accordance with an embodiment of the present invention. The restaurant ordering system exemplarily shows two smartphones 132 and 134, a restaurant service server 102 and a computer terminal 124. The two smartphones 132 and 134 belong to the same group of customers located and being served in a restaurant. The computer terminal 124 belongs to the restaurant to receive customers' orders, requests and instructions. When the smartphone 132 is instructed to transmit an order to the restaurant service server 102, a plurality of packets 512 carrying the order information is transmitted to the restaurant service server 102. Similarly, a plurality of packets 516 carries order information from the smartphone 134 to the restaurant service server 102. The restaurant service server 102 parses the received pluralities of packets 512 and 516, extract restaurant identification information, order contents and serial codes associated with the orders. If the two orders have the same serial codes, the restaurant service server 102 combines the two order contents and creates a new plurality of packets 523 carrying the combined order and then transmits the newly created plurality of packets 523 to the computer terminal 124 identified by the restaurant identification information. After receiving the combined order, the restaurant can proceed to fulfil the order. In embodiments, the pluralities of packets conform to the TCP/IP protocol, and are transmitted over the Internet.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A restaurant ordering system comprising:
a first computing device placed in a restaurant configured to receive orders and instructions over the Internet;
a server in communication with the first computing device over the Internet, the server parsing a first plurality of packets received from a second computing device separated from the first computing device to extract a first order and a first serial code entered in the second computing device, the server parsing a second plurality of packets from a third computing device separated from the first and the second computing device to extract a second order and a second serial code entered in the third computing device, the server creating a third plurality of packets carrying the first order, the second order and the first serial code upon receiving an instruction from either the second or the third computing device or both to do so if the first and the second serial code are the same, and transmitting the third plurality of packets to the first computing device.

2. The restaurant ordering system of claim 1 further comprising a router providing Wi-Fi coverage in a vicinity of the restaurant and the first computing device accessing the Internet through the Wi-Fi.

3. The restaurant ordering system of claim 1, wherein the second and the third computing device are smartphones belonging to individual customers located in the restaurant when the first and the second pluralities of packets are received.

4. The restaurant ordering system of claim 1, wherein the server is also placed in the restaurant.

5. The restaurant ordering system of claim 1, wherein the server is placed in premises of an Internet service provider.

6. The restaurant ordering system of claim 1 further comprising a printer coupled to first computing device for printing orders.

7. The restaurant ordering system of claim 1, wherein the first serial code is generated by the first computing device and associated with a table in the restaurant.

8. The restaurant ordering system of claim 1, wherein the first serial code is generated by the server at a request of the first computing device which associates the request with a table in the restaurant.

9. The restaurant ordering system of claim 1, wherein the first serial code is generated by the server at a request of the second computing device which associates the request with a person's name.

10. The restaurant ordering system of claim 1, wherein the server creates a fourth plurality of packets carrying the second order, and transmits the fourth plurality of packets to the second computing device.

11. The restaurant ordering system of claim 10, wherein the server processes payment information transmitted from the second computing device covering a cost of both the first and the second order.

12. The restaurant ordering system of claim 1, wherein the server operatively retrieves menu and customer feedback information of the restaurant from a database.

13. The restaurant ordering system of claim 1, wherein the server collects feedback information from the second computing device and stores the feedback information in a database wherein the feedback information is associated with a menu item in the first order.

14. A restaurant ordering method comprising:
parsing, by a server, a first plurality of packets received from a first computing device over the Internet;
extracting, by the server, a first order and a first serial code from the first plurality of packets;
parsing, by the sever, a second plurality of packets received from a second computing device over the Internet, wherein the second computing device is separated from the first computing device;
extracting, by the server, a second order and a second serial code from the second plurality of packets;
creating, by the server, a third plurality of packets carrying the first order, the second order and the first serial code upon receiving an instruction from either the first or the second computing device or both to do so if the first and the second serial code are the same; and
transmitting, by the server, the third plurality of packets to a third computing device placed in a restaurant, wherein the third computing device being separated from both the first and second computing device.

15. The restaurant ordering method of claim 14 further comprising providing Wi-Fi coverage in a vicinity of the restaurant with a router and allowing the third computing device to access the Internet through the Wi-Fi.

16. The restaurant ordering method of claim 14, wherein the first and the second computing device are smartphones belonging to individual customers located in the restaurant when the first and the second pluralities of packets are received.

17. The restaurant ordering method of claim 14, wherein the server is also placed in the restaurant.

18. The restaurant ordering method of claim 14, wherein the first serial code is generated by the server at a request of the first computing device which associates the request with a table in the restaurant.

19. The restaurant ordering method of claim 14, wherein the first serial code is generated by the server at a request of the first computing device which associates the request with a person's name.

20. The restaurant ordering method of claim 14, wherein the first serial code is generated by the third computing device and associated with a table in the restaurant.

21. The restaurant ordering method of claim 14 further comprising creating, by the server, a fourth plurality of packets carrying the second order; and transmitting the fourth plurality of packets to the first computing device.

22. The restaurant ordering method of claim 21 further comprising processing, by the server, payment information transmitted from the first computing device covering a cost of both the first and the second order.

23. The restaurant ordering method of claim 14 further comprising retrieving, by the server, menu and customer feedback information of the restaurant from a database.

24. The restaurant ordering method of claim 14 further comprising collecting, by the server, feedback information from the first computing device and stores the feedback information in a database wherein the feedback information is associated with a menu item in the first order.
